(19) United States
(12) Patent Application Publication
(10) Pub. No.: US 2019/0213223 A1
(43) Pub. Date: Jul. 11, 2019

(54) PAGE PROCESSING SYSTEM, METHOD AND APPARATUS FOR PAGE GENERATING AND PAGE INFORMATION PROVIDING

(71) Applicant: ALIBABA GROUP HOLDING LIMITED, George Town (KY)

(72) Inventor: Jian SHEN, Hangzhou (CN)

(73) Assignee: ALIBABA GROUP HOLDING LIMITED

(21) Appl. No.: 16/351,461

(22) Filed: Mar. 12, 2019

Related U.S. Application Data
(63) Continuation of application No. PCT/CN2017/100459, filed on Sep. 5, 2017.

(30) Foreign Application Priority Data
Sep. 12, 2016 (CN) 201610819226.3

(51) Int. Cl. G06F 16/957; G06F 16/9535; G06F 3/0483; G06Q 30/06; G06F 16/9538

(52) U.S. Cl. CPC G06F 16/957; G06F 16/9535; G06F 16/9538; G06Q 30/0643; G06F 3/0483

(57) ABSTRACT

Embodiments of the present disclosure provide a page processing system and methods and apparatuses for page generation and providing page information. The page generating method for providing personalized blocks in a page, can include: providing a component library, wherein the component library includes a personalized block component; receiving block configuration information submitted for a page after the personalized block component is added to a page framework of the page, the block configuration information including a quantity of blocks and data associated with the blocks; and storing the block configuration information such that user information is acquired when the page is accessed by a user, determining a delivery mode information of each block of the blocks with the recorded block configuration information and the user information using an algorithm, and delivering data to the page based on the delivery mode.

### CROSS-REFERENCE TO RELATED APPLICATION

The present disclosure claims the benefits of priority to International Application No. PCT/CN2017/100459, filed Sep. 5, 2017, which claims priority to Chinese Patent Application 201610819226.3, filed on Sep. 12, 2016, both of which are incorporated herein by reference in their entireties.

### TECHNICAL FIELD

The present disclosure generally relates to the field of page processing, and in particular, to a page processing system, methods and apparatuses for page generating and page information providing.

### BACKGROUND

A page usually includes blocks for displaying data objects where each block uses similar data. For such pages, blocks are arranged from top to bottom. Each block can be arranged as a “floor.” For example, in a page displaying mobile phones of various brands, a Brand A block, a Brand B block, and a Brand C block can be arranged in the form of three floors. In addition, related data objects are displayed in the same block. Users who shop online on such a page will have an experience similar to shopping in a brick and mortar store. Therefore, pages for online shopping are often designed with such blocks.

### SUMMARY

Embodiments of the present disclosure provide a page processing system, methods, and apparatuses for page generating and page information providing.

The embodiments of the present disclosure provide a page processing system. The system includes a personalized block component including a page construction module, a user information acquiring module, an algorithm module, and a page data delivering module. The page construction module includes circuitry to receive and record block configuration information defined in a page after the personalized block component is added to a page framework of the page, the block configuration information including a quantity of blocks and data associated with the blocks. The user information acquiring module includes circuitry to acquire user information when the page is accessed by a user and to provide the user information to the algorithm module. The algorithm module includes circuitry to calculate a delivery mode information of each block with the recorded block configuration information and the user information by using an algorithm. The page data delivering module includes circuitry to deliver data to the page based on the delivery mode of each block provided by the algorithm module.

The embodiments also include a page generating method for providing personalized blocks in a page, including: providing a component library including a personalized block component; receiving block configuration information submitted for a page after the personalized block component is added to a page framework of the page, the block configuration information including a quantity of blocks and data associated with the blocks; and storing the block configuration information, acquiring user information when the page being accessed by a user, calculating a delivery mode of each block with the recorded block configuration information and the user information by using an algorithm, and delivering data to the page according to the delivery mode information.

The embodiments also includes a page information providing method for personalizing blocks in a page. A personalized block component is added to a page, block configuration information defined on the page is recorded in the personalized block component. The block configuration information includes a quantity of blocks and data associated with the blocks. The method includes: acquiring user information when a page is accessed by a user; calculating a delivery mode of each block with the recorded block configuration information and the user information by using an algorithm; and delivering data to the page according to the delivery mode of each block.

The embodiments also provide a page generating apparatus, including: a component library providing unit having circuitry to provide a component library, wherein the component library includes a personalized block component; a configuration information receiving unit having circuitry to receive block configuration information submitted for a page after the personalized block component is added to a page framework of the page, the block configuration information including a quantity of blocks and data associated with the blocks; and a configuration information storing unit having circuitry to store the block configuration information, acquire user information when the page is accessed by a user, calculate a delivery mode of each block with the recorded block configuration information and the user information by using an algorithm, and deliver data to the page according to the delivery mode.

The embodiments also include a page information providing apparatus. A personalized block component is added to a page, block configuration information defined on the page is recorded in the personalized block component, and the block configuration information includes a quantity of blocks and data associated with the blocks. The apparatus can include: a user information acquiring unit having circuitry to acquire user information when a page is accessed by a user; a calculating unit having circuitry to calculate a delivery mode of each block with the recorded block configuration information and the user information by using an algorithm; and a data delivering unit having circuitry to deliver data to the page according to the delivery mode of each block.

### BRIEF DESCRIPTION OF THE DRAWINGS

In order to illustrate the technical solutions in the embodiments of the present application or in the prior art more clearly, the accompanying drawings to be used in the embodiments are introduced briefly below. It is apparent that the accompanying drawings in the following description are only some embodiments of the present application.

FIG. 1 is a schematic diagram of an exemplary page processing system according to embodiments of the present disclosure;

FIG. 2 is a schematic diagram of an exemplary first user interface according to embodiments of the present disclosure;

FIG. 3 is a schematic diagram of an exemplary second user interface according to embodiments of the present disclosure;

FIG. 4 is a flowchart of an exemplary method according to embodiments of the present disclosure;

FIG. 5 is a flowchart of another exemplary method according to embodiments of the present disclosure;

FIG. 6 is a schematic diagram of an exemplary apparatus according to embodiments of the present disclosure; and

FIG. 7 is a schematic diagram of another exemplary apparatus according to embodiments of the present disclosure.

### DETAILED DESCRIPTION

In order to facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

Page generation systems such as “Tmall” Zebra System provide a user (page developer) with a number of different components. The user can choose components from a component pool and assemble the components into a page. The assembly process is similar to building blocks. Data objects (for example, merchandise and stores) that are related to the component are arranged in the component. For example, components can be a banner of a page, a floor (which can include four merchandise pits in a row or merchandise pits arranged in other manners), and so on.

The system described above has at least the following problems. The user (page developer) usually manually sorts floors and selects data objects related to the floors to ensure that most users would like contents of the page and that the page has a high click-through rate and a high conversion rate (conversion rate is total sales divided by total number of visitors). However, users with different shopping preferences may close the page if they do not find anything interesting in the page, thereby affecting the page click-through rate and the conversion rate.

In conventional systems, personalization of page content cannot be achieved in. The blocks are independent of each other, and each block corresponds to a component. For example, a page includes three blocks, three components are added to the page framework (functions of the components may be the same), and then, item selection rules in the blocks are defined in the components, respectively. Therefore, the component corresponding to each block can deliver data to the block based on the item selection rule. a page creator needs to determine an order of the blocks. For example, a block of Brand 1 is placed at the top, a block of Brand 2 is placed in the middle, and a block of Brand 3 is placed at the bottom. The order of the blocks is determined when the page is generated, so it cannot be adjusted based on the users' shopping preferences in the display process once the page is published.

According to some embodiments of the present disclosure, personalized page generation are provided to solve the problem that the same contents on the page cannot meet all users' needs. The display mode of the blocks on the page can be adjusted based on users' preferences. In some embodiments, a personalized block processing component can be provided in a component library, and each block can be defined in the component. For example, the quantity of required blocks and data in each block can be defined in the same component, without defining the order of the blocks. When the page is generated, the personalized block processing component can also manage all the blocks. When an access request from a user is received, user information of the user, the data of each block, and other information can be used to calculate by using a preset algorithm a data delivery mode that is most suitable for the user. The data delivery mode can include a block order and a data order in a block. Sorting data objects in the “floor” and sorting “floors” can achieve “personalized pages for different persons.” Different consumers may see different data objects or different order of data objects in the same floor. The differences are caused by various shopping preferences of the consumers. For example, three floors are defined in a page: a Brand A zone, a Brand B zone and a Brand C zone. The system can generate a page with the Brand A block on the top if the system determines that consumer X is a fan of Brand A based on consumer X's shopping history on shopping platforms such as Taobao. Similarly, the system can generate a page with the Brand C block on the top for consumer Y if the system determines that consumer Y is a fan of Brand C.

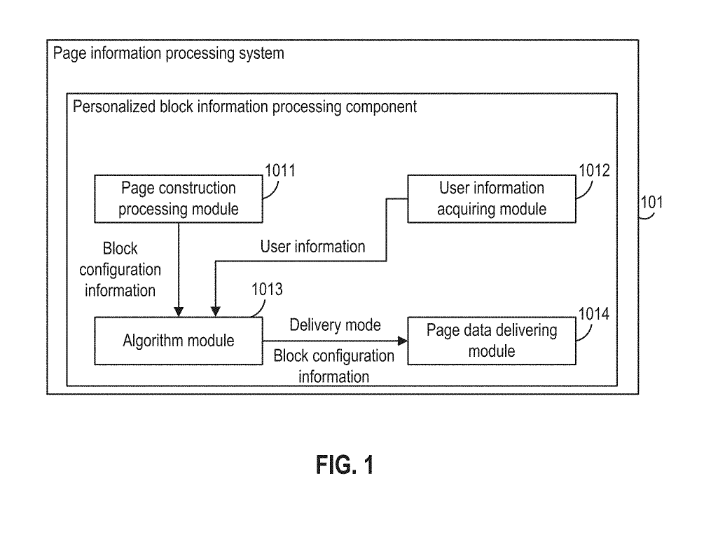

FIG. 1 is a schematic diagram of an exemplary page processing system. Referring to FIG. 1, the system includes a personalized block processing component 101. Personalized block processing component 101 can include a page construction processing module 1011, a user information acquiring module 1012, an algorithm module 1013, and a page data delivering module 1014. Page construction processing module 1011 is configured to receive and record block configuration information defined in a page after personalized block processing component 101 is added to a page framework of the page. The block configuration information includes a quantity of the blocks and data associated with the blocks. User information acquiring module 1012 is configured to acquire user information of a user when the page is accessed and to provide the user information for the algorithm module. Algorithm module 1013 is configured to calculate the recorded block configuration information and the user information by using a preset algorithm to determine a delivery mode of each block. Page data delivering module 1013 is configured to deliver data to the page according to the delivery mode of each block provided by the algorithm module.

A user of the exemplary system can be a page developer for a shopping platform. The page developer can use the system to generate pages. The system can include a plurality of components. Components selected from a component library can form a framework of the page. In some embodiments of the present disclosure, the component library can include a personalized block processing component configured to display personalized data of the blocks on the page. Related data objects are gathered and displayed in a block. The page developer can add the personalized block processing component to a specific location of the page if data objects (for example, merchandise and stores) need to be displayed in blocks. The personalized block information processing component is configured with data such as the quantity of blocks and data associated with each block. In some embodiments, the page developer can only specify blocks and data objects in the blocks for display without sorting the blocks.

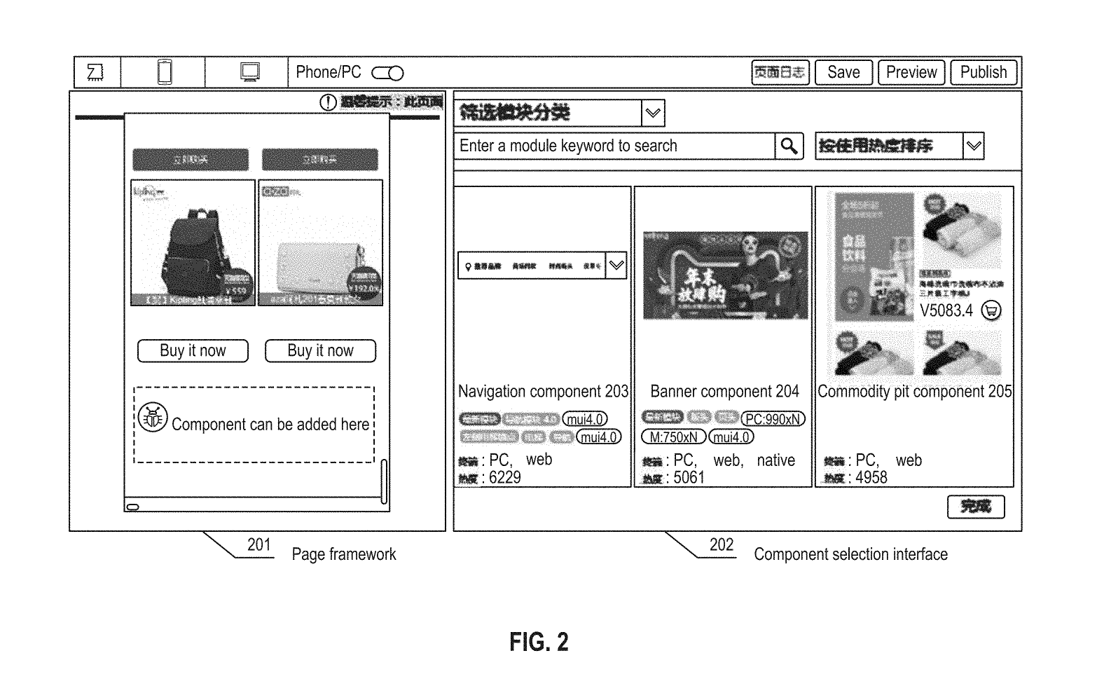

FIG. 2 is a schematic diagram of an exemplary first user interface according to embodiments of the present disclosure. In implementation, the page developer can first create an empty page framework, and then use the page processing system to add components to the page framework. Referring to FIG. 2, the exemplary system can provide various components for selection in the component library through an interface, so that the page developer can preview the page in a component style. Furthermore, the page creator can add the selected components to the page framework of the page by actions such as “dragging” and “clicking.” As shown in FIG. 2, a page framework 201 on the left side is created by the page creator. A component selection interface 202 on the right side can include a navigation component 203, a banner component 204, a commodity pit component 205. Commodity pit component 205 is an example of the personalized block processing component according to the embodiments of the present disclosure. The page developer can add the personalized block processing component in the framework if displaying data objects in blocks on a specific location in the framework is desired.

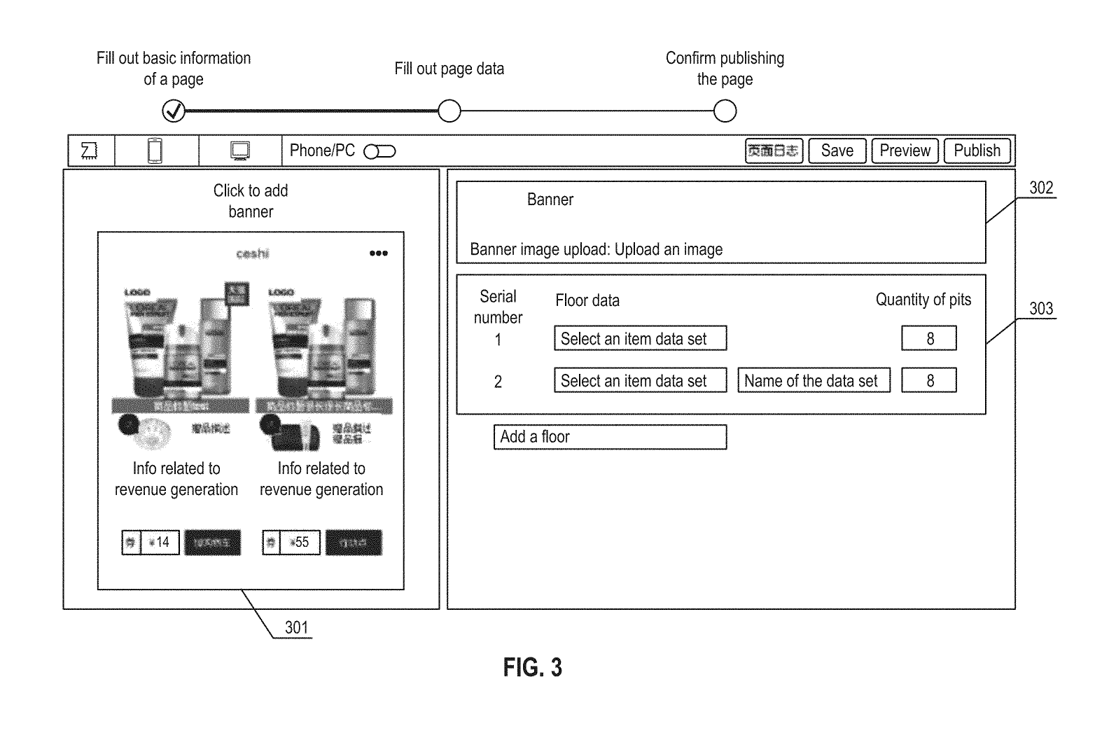

After a component is selected, specific data can be filled in the selected component. For example, clicking on the banner component added to the framework can trigger an interface for adding data to the component. The interface can display, for example, an input box or a selection box. For example, as shown in FIG. 3, an interface 302 can be displayed when “click to add a banner” in an interface 301 is clicked. Interface 302 can display a text “upload a banner image” if the banner is image only and can also provide selectable items for image selection.

When the personalized block processing component is clicked, an interface 303 for submitting block configuration information can be displayed as shown in FIG. 3. The block configuration information can include the quantity of blocks and their associated data information. In actual implementation, item data sets can be pre-determined to facilitate the association of data with blocks. The interface can provide selectable items for adding a block and for selecting a data set for the added block. As such, the system can receive and record the quantity of blocks and data associated with each block. The data information can include data set identifiers. In addition, a selectable item for naming blocks can further be provided. As such, the name of a block can be displayed in a navigation bar when navigation for each block is generated in the navigation component.

The item data set can by created in many ways. In an example, a system for creating a data set can select data from a data source (for example, a specific ranking list) based on a selection rule (for example, the top 20 in a ranking list), an update rule (for example, update once every week) and other rules specified by a user, so as to generate an item data set. The system can also name the generated selection data set and set an id for the item data set for use in page generation.

The same block may include a plurality of resource positions (which can be commonly referred to as “pits”) and data associated with the block, for example, data is displayed in various resource positions in the block. The quantity, the size, and order of each resource position in the block can be defined in the component (the style can be previewed through the above mentioned interface). Therefore, data can be added by selecting a data set. The styles can also be established in the component. For example, a different order of resource positions can be provided for different quantities of resource positions. When the block is configured, the quantity of the resource positions can also be selected in addition to the data set. The quantity of data objects in a data set can generally be 20 or more, while the quantity of resource positions in the same block can be relatively small, such as 6 or 8. When there are more data objects than resource positions in the block, the data objects in the data set can be displayed in turn.

In addition, the data set can include id information of data objects, while each data object can include attributes such as representative images, prices and inventory, which can be used as contents for display in resource positions. Some attributes are selected as the contents for display due to limited space in resource positions. In some embodiments, categories and source of the contents for display can be set. The contents such as the name and the price of the data object can be obtained from a database in a platform. The contents such as discount information and other information related to revenue generation can be obtained from a merchant database where data is provided by merchants and sellers who participate in promotion events.

The page construction processing module can record block configuration information defined in the page. The page is generated and published. Consumers can access the page once the page is published. According to the embodiments of the present disclosure, data delivery information such as a block order based on shopping preferences of users can be calculated, and used to deliver data for personalized display of data in blocks on the page.

Referring back to FIG. 1, the personalized block processing component can also include a user information acquiring module 1012. The module can acquire user information of a front-end user when the page is accessed. For example, the user information can include historical behavior of the user, basic information such as gender and age of the user, can also include labels tagged to the user such as frequent shopper and fan of a certain brand. The user information acquired is provided to algorithm module 1013.

After receiving the user information, algorithm module 1013 can acquire block configuration information including the quantity of blocks, associated data (for example, a data set id), in a current page from the page processing module 1011. The algorithm module can calculate a block delivery mode that is most suitable for the current user with the user information and the block configuration information using a preset algorithm. The delivery mode can include a block order and an item order in the block.

Characteristics of the blocks can be extracted from common attributes of the data objects associated with the blocks. and how the characteristics of the blocks match the user information is used to determine the block order. For example, the data set associated with a block is a terminal device of a certain brand and the block is characterized by a zone of the brand, then how the user likes the brand can be determined during calculation. How a user likes data objects can also be used to determine the order of the data objects in the blocks. The data objects can be merchandise. The user's interest in the merchandise can be determined based on the user's history of clicking on the merchandise, adding the merchandise in favorites and purchasing the merchandise. The merchandise are sorted in an order based on the user's interest. The data objects can also be stores. Stores displayed in a block is sorted in an order based on the user's interest in the stores. One data object can be selected for display in the resource pits and a representative picture of the selected data object can also be used as the representative picture of the store. In this case, while the stores are sorted, the user's interest on the data objects is used to determine the representative picture of the data object. Different users may see blocks in different order, stores in different order, and different representative pictures, all of which are based on the user information.

After the delivery mode of each block is determined, the delivery mode can be provided to the page data delivering module 1014. As such, the page data delivering module 1014 can deliver data to the page according to the delivery mode, which includes a block order and an item order. For example, a Brand B block can be delivered on the first floor if it is determined that the user is most interested in Brand B. The contents of each data object can also be acquired according to the content configuration included in the block configuration information and can be organized for display on the page.

In some embodiments, a block navigation component can be added to the page when multiple blocks are arranged on the page. The component can generate navigation information based on the order and the names of the blocks. For example, users can navigate to a block of a page using the navigation information. In some embodiments, the block order is calculated based on the user information. The navigation information can be generated after a determination of the block order. Specifically, the personalized block component can also provide the block order to the block navigation component for generating navigation information.

In actual implementation, each module in the personalized block component can be implemented by a client, or implemented at a server. Alternatively, some modules can be located at the client, and other modules can be located at the server. For example, the page processing module can be located at a server or a client for page developers, the user information acquiring module can be located at a client for page users, the algorithm module and the page data delivering module can be located at the server.

According to the embodiments of the present disclosure, a personalized block component can be provided in a page processing system. The component can be added to a page during page generation. The system can receive and record block configuration information defined in the page. The block configuration information may not include delivery mode of blocks such as a block order. When the page is accessed, user information is acquired and provided to an algorithm module. The algorithm module can determine a delivery mode of each block with the block configuration information and the user information using a preset algorithm, and then a delivering module delivers data based on the determined delivery mode. As such, the personalized block component can manage different blocks in the same page for personalized display.

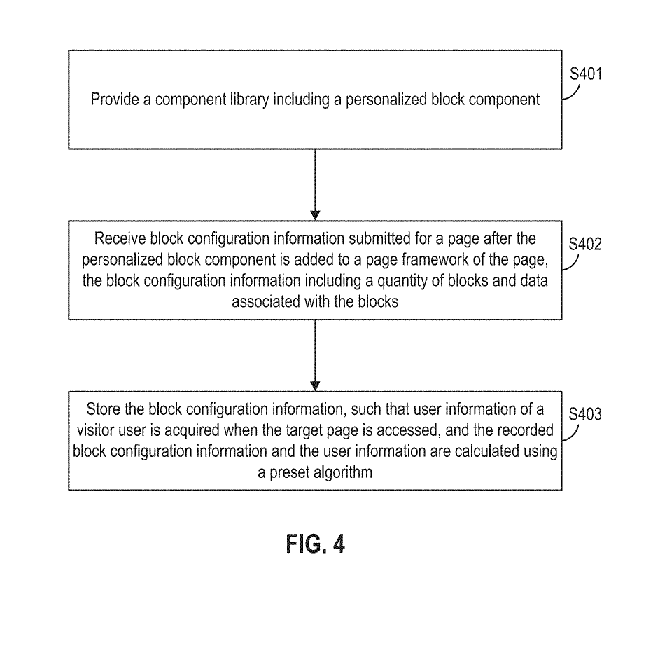

FIG. 4 illustrates a flowchart of an exemplary method, consistent with embodiments of the disclosure. The method can include the following steps.

In step S401, information of a component library is provided. The component library includes a personalized block information processing component. Referring back to FIG. 2, specifically when information of a component library is provided, a preview of the name and display style of each component can be provided in a preset interface for selecting the components and adding the components to a page framework.

In step S402, block configuration information submitted for a page is received after the personalized block component is added to a page framework of the page. The block configuration information includes the quantity of the blocks and data associated with the blocks.

Specifically, when block configuration information is received, a first selectable item for adding a block can be provided. A second selectable item for selecting a preset data set can also be provided in response to a request for adding a block received via the first selectable item. Available data set identifiers are provided for selection in response to a selecting request received via the second selectable item. The selected data set identifier is set as data associated with the block.

In step S403, the block configuration information is stored, such that user information of a visitor user is acquired when the target page is accessed, the block configuration information and the user information are used to determine a delivery mode of each block using a preset algorithm, and data is delivered to the page according to the delivery mode.

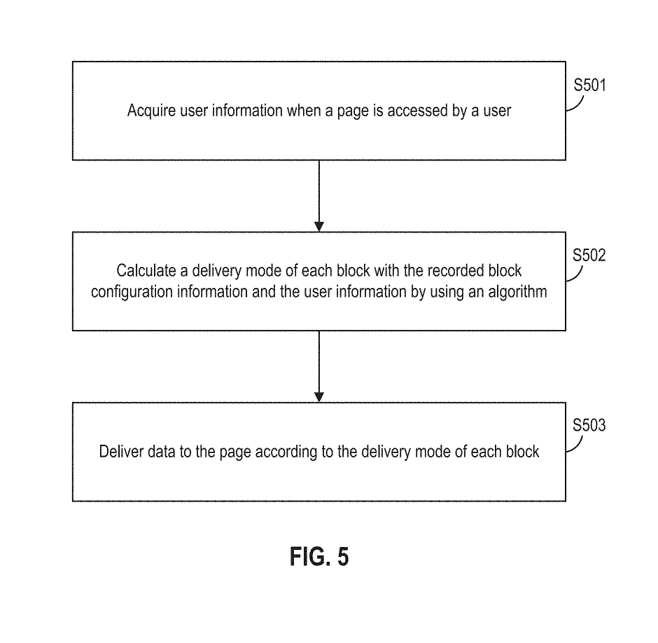

In some embodiments, a method for providing page information is provided. A personalized block component is added to a page, the block configuration information defined on the page is recorded in the personalized block component. The block configuration information includes the quantity of blocks and data associated with the blocks. FIG. 5 is a flowchart of another exemplary method according to embodiments of the present disclosure. Referring to FIG. 5, the exemplary method can include the following steps.

In step S501, user information of a user is acquired when a page is accessed by the user.

In step S502, the recorded block configuration information and the user information are used to determine a delivery mode of each block using a preset algorithm.

In step S503, data is delivered to the page according to the delivery mode of each block.

Specifically, the step of determining a delivery mode of each block includes: determining at least one of a block order or an item order in the blocks.

A block navigation component can also be added to the page. The block order can further be provided to the block navigation component to generate navigation information.

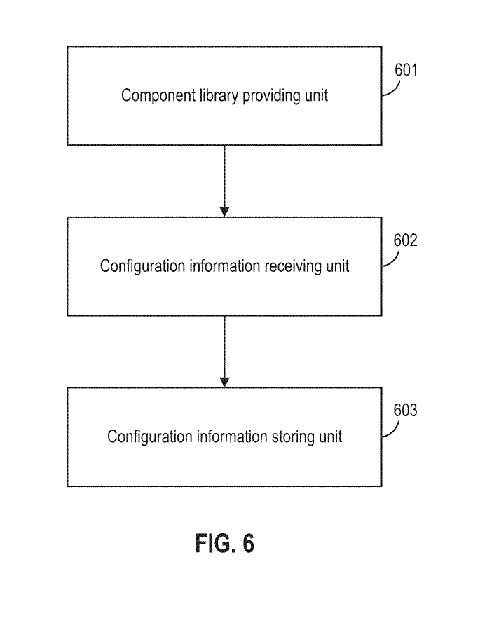

According to embodiments of the present disclosure, a page generating apparatus is provided. FIG. 6 is a schematic diagram of an exemplary apparatus according to embodiments of the present disclosure.

The apparatus can include a component library providing unit 601 configured to provide a component library. The component library includes a personalized block component.

The apparatus can also include a configuration receiving unit 602 configured to receive block configuration information submitted for a page after the personalized block component is added to a page framework of the page. The block configuration information includes the quantity of blocks and data associated with the blocks.

The apparatus can also include a configuration storing unit 603 configured to store the block configuration information, acquire user information of a user when the target page is accessed, determine a delivery mode of each block with the block configuration information and the user information using a preset algorithm, and deliver data to the page according to the delivery mode.

In some embodiments, the component library providing unit 601 can be configured to provide a preview of names and display styles of components in a preset interface for selecting the components and adding the components to the page framework.

The configuration information receiving unit 602 can include: a first operation option providing subunit configured to provide a first selectable item for adding a block, a second operation option providing subunit configured to provide a second selectable item for selecting a data set when a request for adding a block is received through the first selectable item, wherein the data set is established in advance, and a data set providing subunit configured to provide data set identifiers for selection when a selecting request is received through the second selectable item and to determine a selected data set identifier as data associated with the block.

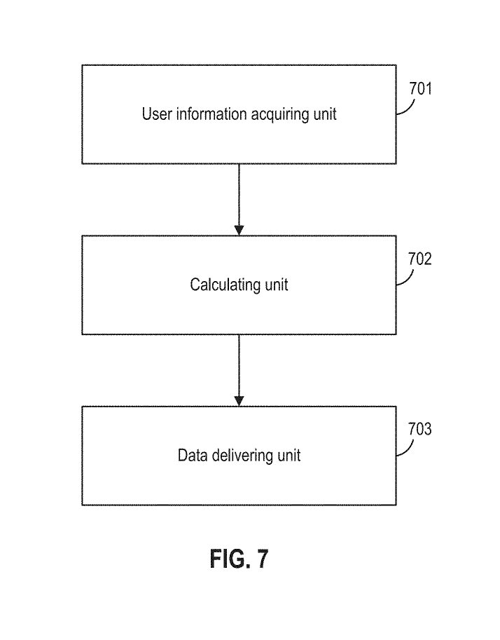

FIG. 7 is a schematic diagram of another exemplary apparatus according to embodiments of the present disclosure. Embodiments of the present disclosure provide an apparatus for providing page information. A personalized block component is added to a page, block configuration information defined on the page is recorded in the personalized block component, and the block configuration information includes the quantity of blocks and data associated with the blocks.

Referring to FIG. 7, the apparatus can include: a user information acquiring unit 701 configured to acquire user information of a user when a page is accessed, a calculating unit 702 configured to determine a delivery mode information of each block with the recorded block configuration information and the user information by using a preset algorithm, and a data delivering unit 703 configured to deliver data to the page according to the delivery mode of each block.

In some embodiments, the delivery mode information of each block is determined by determining at least one of a block order or an item order in the blocks.

In actual implementation, a block navigation component is further added to the page. When the block order is determined, the apparatus can further include a navigation generating unit configured to provide the block order to the block navigation component for generating navigation information based on the block order.

According to embodiments of the present disclosure, a personalized block component can be provided in a page processing system. It is appreciated that the component is added to a page while the page is being generated. The system can receive and record block configuration information defined in the page. When the page is accessed, user information is acquired and provided to an algorithm module. The algorithm module can determine a delivery mode information of each block with the recorded block configuration information and the user information by using a preset algorithm, and then a delivering module delivers data. As such, the personalized block component can manage different blocks in the same page for personalized display, which can improve a page conversion rate.

In some embodiments, a non-transitory computer-readable storage medium including instructions is also provided, and the instructions may be executed by a device for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, any other memory chip or cartridge, and networked versions of the same. The device may include one or more processors (CPUs), an input/output interface, a network interface, and/or a memory.

From the description of the implementation manners above, it is appreciated that the embodiments of the present disclosure may be implemented by software in combination with a universal hardware platform such as a memory and one or more processors. Based on such understanding, the technical solutions of the present application may be embodied in the form of a software product. The computer software product may be stored in a storage medium, such as a ROM/RAM, a magnetic disk, or an optical disc, and include several instructions for instructing a computer device (which may be a personal computer, a server, a network device, or the like) to perform the method in the embodiments or certain portions of the embodiments of the present application.

The embodiments in the specification are described progressively, identical or similar parts of the embodiments may be obtained with reference to each other, and each embodiment emphasizes a part different from other embodiments. Especially, the system or system embodiment provides functionality that is basically similar to the functionality provided by the method embodiment, so it is described simply. The systems and system embodiments described above are merely exemplary. The units described as separate parts may or may not be physically separate, and parts displayed as units may or may not be physical units, may be located in one position, or may be distributed on a plurality of network units. Some or all of the modules may be selected according to achieve the objectives of the solutions of the embodiments.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

1-3. (canceled)

4. A page generating method for personalizing blocks in a page, comprises:
providing a component library comprising a personalized block component;
receiving block configuration information submitted for a page after the personalized block component is added to a page framework of the page, the block configuration information comprising a quantity of blocks and data associated with the blocks; and
storing the block configuration information such that user information is acquired in response to the page being accessed by a user, wherein the stored block configuration information and the user information are used to determine a delivery mode of each block of the blocks and the data is delivered to the page according to the delivery mode.

5. The method according to claim 4, wherein providing a component library comprises:
providing a preview of names and display styles of components in an interface for selecting the components and adding the components to the page framework.

6. The method according to claim 4, wherein receiving block configuration information submitted for a page comprises:
providing a first selectable item for adding a block;
providing a second selectable item for selecting a data set in response to a request for adding a block being received through the first selectable item, wherein the data set is pre-determined; and
providing data set identifiers for selection in response to the second selectable item being selected, and setting the selected data set identifier as data associated with the block.

7-9. (canceled)

10. A page generating apparatus comprising:
one or more memories storing a set of instructions; and
one or more processors configured to execute the set of instructions to cause the page generating apparatus to perform:
providing a component library comprising a personalized block component,
receiving block configuration information submitted for a page after the personalized block component is added to a page framework of the page, the block configuration information comprising a quantity of blocks and data associated with the blocks, and
storing the block configuration information such that user information is acquired in response to the page being accessed by a user, wherein the stored block configuration information and the user information are used to determine a delivery mode of each block of the blocks and the data is delivered to the page according to the delivery mode.

11. The apparatus according to claim 10, wherein providing a component library comprises:
providing a preview of names and display styles of components in an interface for selecting the components and adding the components to the page framework.

12. The apparatus according to claim 10, wherein receiving block configuration information submitted for a page comprises:
providing a first selectable item for adding a block;
providing a second selectable item for selecting a data set in response to a request for adding a block being received through the first selectable item, wherein the data set is pre-determined; and
providing data set identifiers for selection in response to the second selectable item being selected, and setting the selected data set identifier as data associated with the block.

13-15. (canceled)

16. A non-transitory computer readable medium that stores a set of instructions that is executable by at least one processor of a computer to cause the computer to perform a page generating method for personalizing blocks in a page, the method comprising:
providing a component library comprising a personalized block component;
receiving block configuration information submitted for a page after the personalized block component is added to a page framework of the page, the block configuration information comprising a quantity of blocks and data associated with the blocks; and
storing the block configuration information such that user information is acquired in response to the page being accessed by a user, wherein the stored block configuration information and the user information are used to determine a delivery mode of each block of the blocks and the data is delivered to the page according to the delivery mode.

17. The non-transitory computer medium according to claim 16, wherein providing a component library comprises:
providing a preview of names and display styles of components in an interface for selecting the components and adding the components to the page framework.

18. The non-transitory computer medium according to claim 16, wherein receiving block configuration information submitted for a page comprises:
providing a first selectable item for adding a block;
providing a second selectable item for selecting a data set in response to a request for adding a block being received through the first selectable item, wherein the data set is pre-determined; and
providing data set identifiers for selection in response to the second selectable item being selected, and setting the selected data set identifier as data associated with the block.

19-21. (canceled)
